(19) United States
(12) Patent Application Publication
(10) Pub. No.: US 2013/0169354 A1
(43) Pub. Date: Jul. 4, 2013

(54) INTERNAL VOLTAGE GENERATION CIRCUIT

(71) Applicant: Yun Seok HONG, Icheon-si (KR)

(72) Inventor: Yun Seok HONG, Icheon-si (KR)

(73) Assignee: SK HYNIX INC., Icheon-si (KR)

(21) Appl. No.: 13/491,160

(22) Filed: Jun. 7, 2012

(30) Foreign Application Priority Data
Dec. 28, 2011 (KR) 10-2011-0145226

(51) Int. Cl. G05F 3/02

(52) U.S. Cl. 327/540

(57) ABSTRACT

An internal voltage generation circuit includes a comparison signal generation unit configured to compare an internal voltage with first and second reference voltages and generate first and second comparison signals; a transfer unit configured to transfer the first comparison signal as a pull-up signal in response to the second comparison signal, transfer the second comparison signal as a pull-down signal in response to the first comparison signal, transfer a power supply voltage as the pull-up signal when the second comparison signal is enabled and transfer a ground voltage as the pull-down signal when the first comparison signal is enabled; and a driving unit configured to drive a node in response to the pull-up signal and the pull-down signal and generate the internal voltage.

### CROSS-REFERENCES TO RELATED APPLICATIONS

The present application claims priority under 35 U.S.C 119(a) to Korean Application No. 10-2011-0145226, filed on Dec. 28, 2011, in the Korean Intellectual Property Office, which is incorporated herein by reference in its entirety.

### BACKGROUND

1. Technical Field

In general, a semiconductor memory device is supplied with a power supply voltage (VDD) and a ground voltage (VSS) from a source located outside the semiconductor memory device and generates internal voltages which are used for internal operations that are deemed necessary. Voltages necessary for internal operations of a memory device include a core voltage (VCORE) which is used to supply a memory core region, a high voltage (VPP) used for the driving of a word line or overdriving, and a back bias voltage (VBB) which is used to supply the bulk voltage of an NMOS transistor's core region.

Also, the internal voltages include a cell plate voltage (VCP) which is used as the plate voltage of a memory cell capacitor and a bit line precharge voltage (VBLP) used for precharging a bit line. Generally, the cell plate voltage (VCP) and the bit line precharge voltage (VBLP) are generated from the core voltage (VCORE) at one half level of the core voltage (VCORE) for minimizing power consumption.

Normally the cell plate voltage (VCP) and the bit line precharge voltage (VBLP) are generated through the same internal voltage generation circuit. In a conventional internal voltage generation circuit, where the level of the cell plate voltage (VCP) or the bit line precharge voltage (VBLP) is not changed to half the level of the core voltage (VCORE), the driving of the internal voltage (VCP/VBLP) becomes interrupted. Additionally, where the level of the cell plate voltage (VCP) or the bit line precharge voltage (VBLP) is higher or lower than half the level of the core voltage (VCORE), the cell plate voltage (VCP) or the bit line precharge voltage (VBLP) becomes driven. In the state where the level of the cell plate voltage (VCP) or the bit line precharge voltage (VBLP) is not changed to half the level of the core voltage (VCORE) and is thus not driven, is referred to as a dead zone.

2. Related Art

The conventional internal voltage generation circuit is configured in such a way as to compare the internal voltage (VCP/VBLP) with a plurality of reference voltages and then drive the internal voltage (VCP/VBLP). When the internal voltage generation circuit is configured in this way and when the internal voltage (VCP/VBLP) has a voltage level between a reference voltage with a high level voltage and a reference voltage with a low level voltage, a dead zone, in which the internal voltage (VCP/VBLP) is not driven, is formed.

However, in the event that the levels of the reference voltages inputted into the internal voltage generation circuit are changed according to variations in PVT (process, voltage and temperature), that is, when an offset occurs, the levels of the reference voltage with the high level voltage and the reference voltage with the low level voltage may be reversed. If the levels of the reference voltages are reversed, the dead zone, in which the internal voltage (VCP/VBLP) is not driven, disappears, and a short circuit current is likely to be produced.

### BRIEF SUMMARY

Embodiments of the present invention relate to an internal voltage generation circuit which can maintain a dead zone even when the levels of reference voltages are reversed according to variations in PVT properties, thereby preventing a short circuit current from being produced.

In an embodiment of the present invention, an internal voltage generation circuit includes: a comparison signal generation unit configured to compare an internal voltage with first and second reference voltages and generate first and second comparison signals; a transfer unit configured to transfer the first comparison signal as a pull-up signal in response to the second comparison signal, transfer the second comparison signal as a pull-down signal in response to the first comparison signal, transfer a power supply voltage as the pull-up signal when the second comparison signal is enabled and transfer a ground voltage as the pull-down signal when the first comparison signal is enabled; and a driving unit configured to drive a node in response to the pull-up signal and the pull-down signal and generate the internal voltage.

In another embodiment, an internal voltage generation circuit includes: a comparison signal generation unit configured to compare an internal voltage with first and second reference voltages and generate first and second comparison signals; a transfer unit configured to transfer the first comparison signal as a pull-up signal in response to the second comparison signal and transfer a power supply voltage as the pull-up signal when the second comparison signal is enabled; and a driving unit configured to drive a node in response to the pull-up signal and generate the internal voltage.

### BRIEF DESCRIPTION OF THE DRAWINGS

The above and other aspects, features and other advantages will be more clearly understood from the following detailed description taken in conjunction with the accompanying drawings, in which:

FIG. 1 is a circuit diagram showing an example of a configuration of an internal voltage generation circuit in accordance with an embodiment of the present invention;

FIG. 2 is an example of a graph (current verses internal voltage) showing a dead zone period in the case where the levels of reference voltages are not reversed according to variations in PVT properties; and

FIG. 3 is an example of a graph (current verses internal voltage) showing a dead zone period in the case where the levels of reference voltages are reversed according to variations in PVT properties.

### DESCRIPTION OF EMBODIMENTS

Hereinafter, various embodiments of the present invention will be described with reference to accompanying drawings. However, the embodiments are for illustrative purposes only and are not intended to limit the scope of the invention.

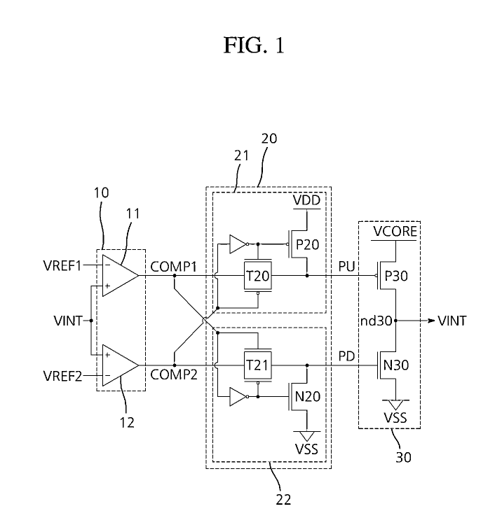

FIG. 1 is an example of a circuit diagram showing the configuration of an internal voltage generation circuit in accordance with an embodiment of the present invention.

Referring to FIG. 1, the internal voltage generation circuit in accordance with the embodiment of the present invention may include a comparison signal generation unit 10 configured to compare an internal voltage VINT with the first and second reference voltages VREF1 and VREF2, respectively, and generate first and second comparison signals COMP1 and COMP2, respectively. Also, the internal voltage generation circuit in accordance with the embodiment of the present invention may include a transfer unit 20 configured to accept the second comparison signal COMP2 and transfer the first comparison signal COMP1 or a power supply voltage VDD as a pull-up signal PU. The transfer unit 20 may also be configured to accept the first comparison signal COMP1 and transfer the second comparison signal COMP2 or a ground voltage VSS as a pull-down signal PD. Additionally, the internal voltage generation circuit in accordance with the embodiment of the present invention may include a driving unit 30 configured to accept the pull-up signal PU and the pull-down signal PD, drive a node nd30, and generate the internal voltage VINT.

The comparison signal generation unit 10 may include a first comparator 11 configured to compare the first reference voltage VREF1 with the internal voltage VINT and then generate the first comparison signal COMP1. The comparison signal generation unit 10 may also include a second comparator 12 configured to compare the second reference voltage VREF2 with the internal voltage VINT and then generate the second comparison signal COMP2. The first reference voltage VREF1 may be set to have a voltage level lower than the second reference voltage VREF2. The first comparison signal COMP1 may be disabled to a logic high level when the internal voltage VINT has a voltage level higher than the first reference voltage VREF1, and may be enabled to a logic low level when the internal voltage VINT has a voltage level lower than the first reference voltage VREF1. The second comparison signal COMP2 may be enabled to a logic high level when the internal voltage VINT has a voltage level higher than the second reference voltage VREF2, and may be disabled to a logic low level when the internal voltage VINT has a voltage level lower than the second reference voltage VREF2.

The transfer unit 20 may include a first transfer section 21 configured for accepting the second comparison signal COMP2 and transferring the first comparison signal COMP1 or the power supply voltage VDD as the pull-up signal PU. Also, the transfer unit 20 may include a second transfer section 22 configured for accepting the first comparison signal COMP1 and transferring the second comparison signal COMP2 or the ground voltage VSS as the pull-down signal PD.

Additionally, the first transfer section 21 may have a first transfer gate T20 which may be turned on and transferring the first comparison signal COMP1 as the pull-up signal PU when the second comparison signal COMP2 is disabled to the logic low level. The first transfer section 21 may also have a first switch element P20 which may be turned on and transferring the power supply voltage VDD as the pull-up signal PU when the second comparison signal COMP2 is enabled to the logic high level. The second transfer section 22 may have a second transfer gate T21 which may be turned on and transferring the second comparison signal COMP2 as the pull-down signal PD when the first comparison signal COMP1 is disabled to the logic high level. The second transfer section 22 may also have a second switch element N20 which may be turned on and transferring the ground voltage VSS as the pull-down signal PD when the first comparison signal COMP1 is enabled to the logic low level.

The driving unit 30 may include a pull-up element P30 which when turned on, the pull-up may drive the node nd30 and generate the internal voltage VINT when the pull-up signal PU is enabled to a logic low level. The driving unit 30 may also include a pull-down element N30 which when turned on, the pull-down may drive the node nd30 and generate the internal voltage VINT when the pull-down signal PD is enabled to a logic high level.

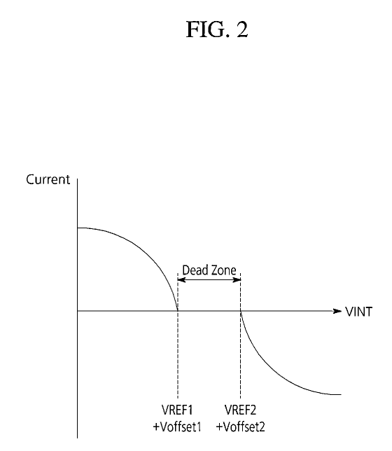

Operations of the internal voltage generation circuit configured in this way will be described below with reference to FIG. 2, on the assumption that the level of the first reference voltage VREF1, which is changed according to a first offset voltage Voffset1 generated due to variations in PVT (process, voltage and temperature), is lower than the level of the second reference voltage VREF2, which is changed according to a second offset voltage Voffset2 generated due to variations in PVT.

First, in the case where the level of the internal voltage VINT is lower than the sum of the first reference voltage VREF1 and the first offset voltage Voffset1, the first comparator 11 may compare the internal voltage VINT and the first reference voltage VREF1 and generate the first comparison signal COMP1 having a logic low level, and the second comparator 12 may compare the internal voltage VINT to the second reference voltage VREF2 and generate the second comparison signal COMP2 having a logic low level.

The first transfer gate T20 of the first transfer section 21 may be turned on by inputting a second comparison signal COMP2 at a logic low level and transferring the first comparison signal COMP1 having a logic low level as the pull-up signal PU. At this time, the first switch element P20 may be turned off by inputting the inverted signal of the second comparison signal COMP2 having a logic low level, thereby not transferring the power supply voltage VDD as the pull-up signal PU.

The second transfer gate T21 of the second transfer section 22 may be turned off by inputting a first comparison signal COMP1 at a logic low level and not transferring the second comparison signal COMP2 as the pull-down signal PD. At this time, the second switch element N20 may be turned on by inputting the inverted signal of the first comparison signal COMP1 having a logic low level, thereby transferring the ground voltage VSS as the pull-down signal PD.

The pull-up element P30 of the driving unit 30 may be turned on by inputting the pull-up signal PU having a logic low level, thus allowing the pull-up signal PU to drive the node nd30, and raise the level of the internal voltage VINT. At this time, the pull-down element N30 may be turned off by inputting a pull-down signal PD having a logic low level, thereby not allowing the pull-down signal PD to drive the node nd30.

Alternatively, in the case where the level of the internal voltage VINT is higher than the sum of the first reference voltage VREF1 and the first offset voltage Voffset1, and lower than the sum of the second reference voltage VREF2 and the second offset voltage Voffset2, the first comparator 11 may compare the internal voltage VINT and the first reference voltage VREF1 and generate the first comparison signal COMP1 having a logic high level, and the second comparator 12 may compare the internal voltage VINT to the second reference voltage VREF2 and generate the second comparison signal COMP2 having a logic low level.

The first transfer gate T20 of the first transfer section 21 may be turned on by inputting a second comparison signal COMP2 at a logic low level and transferring the first comparison signal COMP1 as the pull-up signal PU and thereby implementing a logic high level as the pull-up signal PU. At this time, the first switch element P20 is turned off by inputting the inverted signal of the second comparison signal COMP2 having a logic low level, thereby not transferring the power supply voltage VDD as the pull-up signal PU.

The second transfer gate T21 of the second transfer section 22 may be turned on by inputting the first comparison signal COMP1 having a logic high level and transferring the second comparison signal COMP2 having a logic low level as the pull-down signal PD. At this time, the second switch element N20 may be turned off by inputting the inverted signal of the first comparison signal COMP1 having a logic high level and thereby not transferring the ground voltage VSS as the pull-down signal PD.

The pull-up element P30 of the driving unit 30 may be turned off by inputting a pull-up signal PU having a logic high level, thus not allowing the pull-up signal PU to drive the node nd30. At this time, the pull-down element N30 may be turned off by inputting the pull-down signal PD having a logic low level, and thus not allowing the pull-down signal PD to drive the node nd30. That is to say, when both the pull-up element P30 and the pull-down element N30 are turned off, the internal voltage VINT may not be driven, by which a dead zone Dead Zone may be formed.

Then, in the case where the level of the internal voltage VINT is higher than the sum of the second reference voltage VREF2 and the second offset voltage Voffset2, the first comparator 11 may compare the internal voltage VINT and the first reference voltage VREF1 and generate the first comparison signal COMP1 having a logic high level, and the second comparator 12 may compare the internal voltage VINT and the second reference voltage VREF2 and generate the second comparison signal COMP2 having a logic high level.

The first transfer gate T20 of the first transfer section 21 may be turned off by inputting a second comparison signal COMP2 at a logic high level, thereby not transferring the first comparison signal COMP1 having a logic high level as the pull-up signal PU. At this time, the first switch element P20 may be turned on by inputting an inverted signal of the second comparison signal COMP2 having a logic high level, thereby transferring the power supply voltage VDD as the pull-up signal PU.

The second transfer gate T21 of the second transfer section 22 may be turned on by inputting the first comparison signal COMP1 at a logic high level and transferring the second comparison signal COMP2 having a logic high level as the pull-down signal PD. At this time, the second switch element N20 may be turned off by inputting the inverted signal of the first comparison signal COMP1 having a logic high level, thereby not transferring the ground voltage VSS as the pull-down signal PD.

The pull-up element P30 of the driving unit 30 may be turned off by inputting a pull-up signal PU having a logic high level, thus not allowing the pull-up signal PU to drive the node nd30. At this time, the pull-down element N30 may be turned on by inputting the pull-down signal PD having a logic high level, thus allowing the pull-down signal PD to drive the node nd30, and, therefore, lowering the level of the internal voltage VINT.

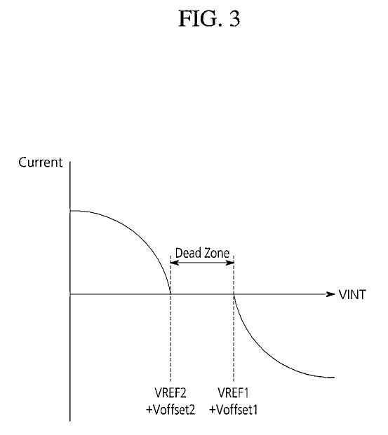

Operations of the internal voltage generation circuit configured as described above will be described below with reference to FIG. 3, on the assumption that the level of the first reference voltage VREF1, which may be changed according to a first offset voltage Voffset1 generated due to variations in PVT (process, voltage and temperature), and the level of the second reference voltage VREF2, which may be changed according to a second offset voltage Voffset2 generated due to variations in PVT, are reversed.

First, in the case where the level of the internal voltage VINT is lower than the sum of the second reference voltage VREF2 and the second offset voltage Voffset2, the first comparator 11 may compare the internal voltage VINT and the first reference voltage VREF1 and generate the first comparison signal COMP1 having a logic low level, and the second comparator 12 may compare the internal voltage VINT to the second reference voltage VREF2 and generate the second comparison signal COMP2 having a logic low level.

The first transfer gate T20 of the first transfer section 21 may be turned on by inputting a second comparison signal COMP2 having a logic low level and transferring the first comparison signal COMP1 having the logic low level as the pull-up signal PU. At this time, the first switch element P20 may be turned off by inputting the inverted signal of the second comparison signal COMP2 having a logic low level, thereby not transferring the power supply voltage VDD as the pull-up signal PU.

The second transfer gate T21 of the second transfer section 22 may be turned off by inputting the first comparison signal COMP1 having a logic low level, thereby not transferring the second comparison signal COMP2 as the pull-down signal PD. At this time, the second switch element N20 may be turned on by inputting the inverted signal of the first comparison signal COMP1 having a logic low level, thereby transferring the ground voltage VSS as the pull-down signal PD.

The pull-up element P30 of the driving unit 30 may be turned on by inputting the pull-up signal PU having a logic low level, thus allowing the pull-up signal PU to drive the node nd30, and raise the level of the internal voltage VINT. At this time, the pull-down element N30 may be turned off by inputting the pull-down signal PD having a logic low level, thus not allowing the pull-down signal PD to drive the node nd30.

Alternatively, in the case where the level of the internal voltage VINT is higher than the sum of the second reference voltage VREF2 and the second offset voltage Voffset2 and lower than the sum of the first reference voltage VREF1 and the first offset voltage Voffset1, the first comparator 11 may compare the internal voltage VINT and the first reference voltage VREF1 and generate the first comparison signal COMP1 having a logic low level, and the second comparator 12 may compare the internal voltage VINT to the second reference voltage VREF2 and generate the second comparison signal COMP2 having a logic high level.

The first transfer gate T20 of the first transfer section 21 may be turned off by inputting the second comparison signal COMP2 having a logic high level, thereby not allowing the first comparison signal COMP1, having a logic low level, to transfer as the pull-up signal PU. At this time, the first switch element P20 may be turned on by inputting the inverted signal of the second comparison signal COMP2 having a logic high level, thus transferring the power supply voltage VDD as the pull-up signal PU.

The second transfer gate T21 of the second transfer section 22 may be turned off by inputting the first comparison signal COMP1 having a logic low level, thereby not transferring the second comparison signal COMP2 having a logic high level as the pull-down signal PD. At this time, the second switch element N20 may be turned on by inputting the inverted signal of the first comparison signal COMP1 having a logic low level, thereby transferring the ground voltage VSS as the pull-down signal PD.

The pull-up element P30 of the driving unit 30 may be turned off by inputting the pull-up signal PU having a logic high level, thus not allowing the pull-up signal PU to drive the node nd30. At this time, the pull-down element N30 may be turned off by inputting the pull-down signal PD having a logic low level, thus not allowing the pull-down signal PD to drive the node nd30. That is to say, since both the pull-up element P30 and the pull-down element N30 are turned off, the internal voltage VINT may not be driven, by which a dead zone Dead Zone may be formed.

Then, in the case where the level of the internal voltage VINT is higher than the sum of the first reference voltage VREF1 and the first offset voltage Voffset1, the first comparator 11 may compare the internal voltage VINT and the first reference voltage VREF1 and generate the first comparison signal COMP1 having a logic high level, and the second comparator 12 may compare the internal voltage VINT and the second reference voltage VREF2 and generate the second comparison signal COMP2 having a logic high level.

The first transfer gate T20 of the first transfer section 21 may be turned off by inputting the second comparison signal COMP2 having a logic high level and thus not transferring the first comparison signal COMP1 having a logic high level as the pull-up signal PU. At this time, the first switch element P20 may be turned on by inputting the inverted signal of the second comparison signal COMP2 having a logic high level, thus transferring the power supply voltage VDD as the pull-up signal PU.

The second transfer gate T21 of the second transfer section 22 may be turned on by inputting the first comparison signal COMP1 having a logic high level, thus allowing the transfer of the second comparison signal COMP2 having a logic high level as the pull-down signal PD. At this time, the second switch element N20 may be turned off by inputting the inverted signal of the first comparison signal COMP1 having a logic high level, thereby not transferring the ground voltage VSS as the pull-down signal PD.

The pull-up element P30 of the driving unit 30 may be turned off by inputting the pull-up signal PU having a logic high level, thus not allowing the pull-up signal PU to drive the node nd30. At this time, the pull-down element N30 may be turned on by inputting the pull-down signal PD having a logic high level, therefore allowing the pull-down signal PD to drive the node nd30, and lower the level of the internal voltage VINT.

As described above, in the internal voltage generation circuit in accordance with the embodiment of the present invention, even when an offset occurs between reference voltages, both the pull-up signal PU and the pull-down signal PD for driving the driving unit 30 may be disabled such that the internal voltage VINT may not be driven. As a consequence, in the internal voltage generation circuit in accordance with the embodiment of the present invention, a dead zone may not disappear, and thus, it may be possible to prevent production of short circuit current due to the fact that both the pull-up element P30 and the pull-down element N30 are simultaneously turned on.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An internal voltage generation circuit comprising:
a comparison signal generation unit configured to compare an internal voltage with first and second reference voltages and generate first and second comparison signals;
a transfer unit configured to transfer the first comparison signal as a pull-up signal in response to the second comparison signal, transfer the second comparison signal as a pull-down signal in response to the first comparison signal, transfer a power supply voltage as the pull-up signal when the second comparison signal is enabled and transfer a ground voltage as the pull-down signal when the first comparison signal is enabled; and
a driving unit configured to drive a node in response to the pull-up signal and the pull-down signal and generate the internal voltage.

2. The internal voltage generation circuit according to claim 1, wherein the comparison signal generation unit comprises:
a first comparator configured to compare the internal voltage and the first reference voltage and generate the first comparison signal; and
a second comparator configured to compare the internal voltage and the second reference voltage and generate the second comparison signal.

3. The internal voltage generation circuit according to claim 2, wherein the first reference voltage is capable of being set to a lower voltage level than the second reference voltage.

4. The internal voltage generation circuit according to claim 2, wherein the first comparison signal is enabled when the internal voltage has a lower voltage level than the first reference voltage.

5. The internal voltage generation circuit according to claim 2, wherein the second comparison signal is enabled when the internal voltage has a higher voltage level than the second reference voltage.

6. The internal voltage generation circuit according to claim 2, wherein the first and second comparison signals are become enabled when the first reference voltage changes from having a lower voltage level than the second reference voltage to having a higher voltage level than the second reference voltage due to a variation in PVT (process, voltage, and temperature) and the internal voltage has a voltage level between the first and second reference voltages.

7. The internal voltage generation circuit according to claim 1, wherein the transfer unit comprises:
a first transfer section configured to transfer the first comparison signal as the pull-up signal in response to the second comparison signal or transfer the power supply voltage as the pull-up signal; and
a second transfer section configured to transfer the second comparison signal as the pull-down signal in response to the first comparison signal or transfer the ground voltage as the pull-down signal.

8. The internal voltage generation circuit according to claim 7, wherein the first transfer section comprises:
a first transfer gate configured to transfer the first comparison signal as the pull-up signal in response to the second comparison signal; and
a first switch element configured to transfer the power supply voltage as the pull-up signal in response to the second comparison signal.

9. The internal voltage generation circuit according to claim 7, wherein the second transfer section comprises:
a second transfer gate configured to transfer the second comparison signal as the pull-down signal in response to the first comparison signal; and
a second switch element configured to transfer the ground voltage as the pull-down signal in response to the first comparison signal.

10. The internal voltage generation circuit according to claim 8, wherein the pull-up signal is a signal which is disabled when the second comparison signal is enabled.

11. The internal voltage generation circuit according to claim 9, wherein the pull-down signal is a signal which is disabled when the first comparison signal is enabled.

12. The internal voltage generation circuit according to claim 1, wherein the driving unit generates the internal voltage by using the pull-up signal to drive the node when the pull-up signal is enabled and using the pull-down signal to drive the node when the pull-down signal is enabled.

13. An internal voltage generation circuit comprising:
a comparison signal generation unit configured to compare an internal voltage with first and second reference voltages and generate first and second comparison signals;
a transfer unit configured to transfer the first comparison signal as a pull-up signal in response to the second comparison signal and transfer a power supply voltage as the pull-up signal when the second comparison signal is enabled; and
a driving unit configured to drive a node in response to the pull-up signal and generate the internal voltage.

14. The internal voltage generation circuit according to claim 13, wherein the comparison signal generation unit comprises:
a first comparator configured to compare the internal voltage and the first reference voltage and generate the first comparison signal; and
a second comparator configured to compare the internal voltage and the second reference voltage and generate the second comparison signal.

15. The internal voltage generation circuit according to claim 14, wherein the first reference voltage is capable of being set to a lower voltage level than the second reference voltage.

16. The internal voltage generation circuit according to claim 14, wherein the first comparison signal is enabled when the internal voltage has a lower voltage level than the first reference voltage.

17. The internal voltage generation circuit according to claim 14, wherein the second comparison signal is enabled when the internal voltage has a higher voltage level than the second reference voltage.

18. The internal voltage generation circuit according to claim 14, wherein the first and second comparison signals are become enabled when the first reference voltage changes from having a lower voltage level than the second reference voltage to having a higher voltage level than the second reference voltage due to a variation in PVT (process, voltage and temperature) and the internal voltage has a voltage level between the first and second reference voltages.

19. The internal voltage generation circuit according to claim 13, wherein the transfer unit comprises:
a first transfer gate configured to transfer the first comparison signal as the pull-up signal in response to the second comparison signal; and
a first switch element configured to transfer the power supply voltage as the pull-up signal in response to the second comparison signal.

20. The internal voltage generation circuit according to claim 19, wherein the transfer unit further comprises:
a second transfer gate configured to transfer the second comparison signal as a pull-down signal in response to the first comparison signal; and
a second switch element configured to transfer a ground voltage as the pull-down signal in response to the first comparison signal.

21. The internal voltage generation circuit according to claim 20, wherein the driving unit pull-up drives the node when the pull-up signal is enabled.

22. The internal voltage generation circuit according to claim 21, wherein the driving unit pull-down drives the node when the pull-down signal is enabled.
